(19) United States
(12) Patent Application Publication
(10) Pub. No.: US 2019/0236529 A1
(43) Pub. Date: Aug. 1, 2019

(54) DEVICE AND METHOD FOR ORDER DISTRIBUTION

(71) Applicant: BEIJING DIDI INFINITY TECHNOLOGYT AND DEVELOPMENT CO.,LTD., Beijing (CN)

(72) Inventor: Licong SONG, Beijing (CN)

(73) Assignee: BEIJING DIDI INFINITY TECHNOLOGYT AND DEVELOPMENT CO.,LTD., Beijing (CN)

(21) Appl. No.: 16/234,082

(22) Filed: Dec. 27, 2018

Related U.S. Application Data
(63) Continuation of application No. PCT/CN2017/101776, filed on Sep. 14, 2017.

(30) Foreign Application Priority Data
Oct. 31, 2016 (CN) 201610930788.5

(51) Int. Cl. G06Q 10/08; G06Q 30/06

(52) U.S. Cl. CPC G06Q 10/087; G06Q 10/08355; G06Q 10/0832; G06Q 30/0635

(57) ABSTRACT

A method for order distribution is disclosed. The method may include determining, in a preset order distribution (POD) mode, a service area of an order-receiving user; determining a target order from orders to be distributed based on the service area of the order-receiving user; and pushing the target order to the order-receiving user.

### CROSS-REFERENCE TO RELATED APPLICATION

The present application is based on and claims priority to Chinese Application No. 201610930788.5, filed Oct. 31, 2016, the entire contents of which is incorporated herein by reference.

### TECHNICAL FIELD

The disclosure relates generally to computer technology, particularly, to a method and a device for order distribution.

### BACKGROUND

In general, occurrence of certain events, such as special type of weather (blizzard, tornado, rainstorm, etc.), major holidays and large scale social events, etc., usually are companied with traffic congestions. In such cases, travelling becomes very inconvenient, and demands for some O2O (online-to-offline) services (such as booking a taxi, delivery, etc.) may increase dramatically. Also, due to traffic congestions, efficiency of these O2O services may be affected. If an order is distributed according to a method of order distribution as usually, it is possible that the service resources cannot be optimized in the area where the service demand is larger. As a result, the service resources may be wasted, and the service efficiency may be reduced.

To optimize order distribution in a certain event, reduce waste of service resources and improve service efficiency, this disclosure proposes a method and a device for order distribution in a preset order distribution mode.

### SUMMARY

One aspect of the present disclosure is directed to a method for order. The method may include determining, in a preset order distribution mode, a service area of an order-receiving user; determining a target order from orders to be distributed based on the service area of the order-receiving user; and pushing the target order to the order-receiving user.

Another aspect of the present disclosure is directed to a device for order distribution. The device may include a first determination unit, an acquisition unit and a pushing unit. The first determination unit may be configured to determine a service area of an order-receiving user. The acquisition unit may be configured to determine, in a preset order distribution mode, a target order from orders to be distributed based on the service area of an order-receiving user. The pushing unit may be configured to push the target order to the order-receiving user.

Another aspect of the present disclosure is directed to a non-transitory computer-readable medium for order distribution. The non-transitory computer-readable medium may include instructions stored therein. The instructions, when executed by one or more processors, may cause the one or more processors to perform a method for order distribution. The method may include determining, in a preset order distribution mode, a service area of an order-receiving user; determining a target order from orders to be distributed based on the service area of the order-receiving user; and pushing the target order to the order-receiving user.

It is to be understood that the foregoing general description and the following detailed description are exemplary and explanatory only, and are not restrictive of the invention, as claimed.

### BRIEF DESCRIPTION OF THE DRAWINGS

The accompanying drawings, which constitute a part of this disclosure, illustrate several non-limiting embodiments and, together with the description, serve to explain the disclosed principles.

FIG. 1 is a graphical illustration showing an exemplary scenario of order distribution, consistent with exemplary embodiments of the present disclosure.

FIG. 2 is a flow diagram illustrating a method of order distribution in a POD mode, consistent with exemplary embodiments of the present disclosure.

FIG. 3 is a flow diagram illustrating another method of order distribution in a POD mode, consistent with exemplary embodiments of the present disclosure.

FIG. 4 is a flow diagram illustrating another method of order distribution in a POD mode, consistent with exemplary embodiments of the present disclosure.

FIG. 5 is a graphical presentation illustrating exemplary service areas, consistent with exemplary embodiments of the present disclosure.

FIG. 6 is a block diagram of a device for order distribution in the POD mode, consistent with exemplary embodiments of the present disclosure.

### DETAILED DESCRIPTION OF THE EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments consistent with the present invention do not represent all implementations consistent with the invention. Instead, they are merely examples of systems and methods consistent with aspects related to the invention.

While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. As used herein, the terms “and” and “or” can be construed in either an inclusive or exclusive sense and can refer to any one of or all of the one or more items connected by the terms.

It also should be understood that the terms “first,” “second,” and “third” are used to distinguish one element, set, data, object, step, process, activity or thing from another, and are not used to limit or designate relative position or arrangement in time, unless otherwise stated explicitly. For example, the phrase “first area” can be called “second area,” and similarly, “second area” can be called “first area.” Based on the context, the term “if” can be interpreted as “when,” “at the time,” or “in response to.”

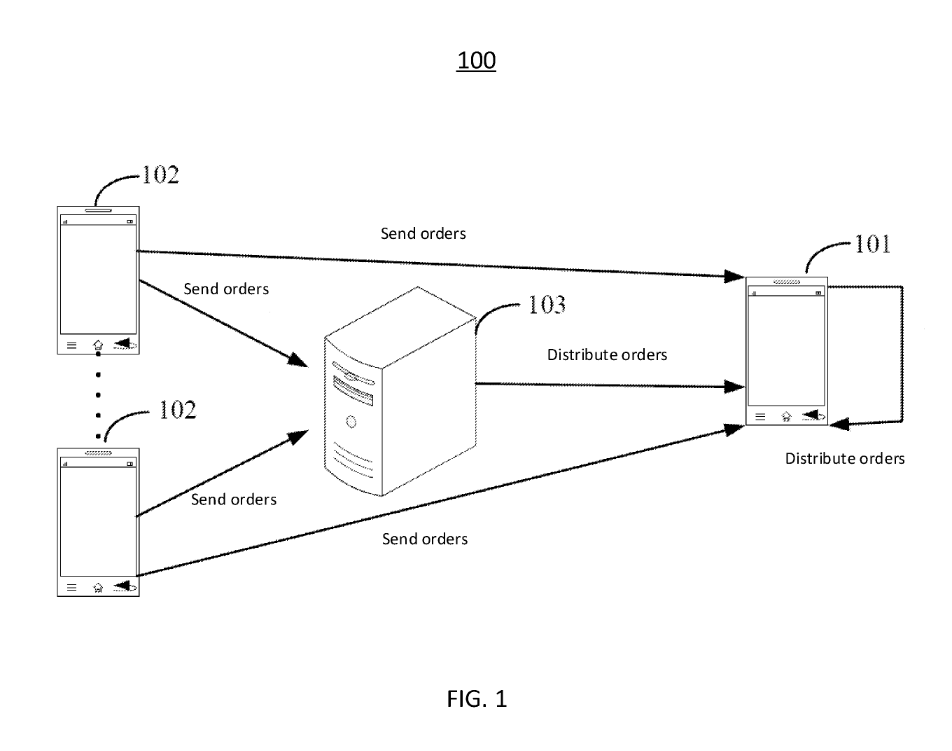

FIG. 1 is a graphical illustration showing an exemplary scenario 100 of order distribution, in accordance with exemplary embodiments of the present disclosure. The scenario 100 may include one or more order-receiving terminal device 101, one or more order-generating terminal device 102, and a server 103. The order-receiving terminal device 101 may be a mobile terminal of an order-receiving user, and configured to receive orders. The order-generating terminal device 102 may be a mobile terminal of an order-generating user, and configured to generate and send orders. The sever 103 may be configured to determine a service area of an order-receiving user. A service area refers to an area where the order-receiving user may provide services. It may be a city, a district, or any geographical area.

In one embodiment, the order-generating terminal device 102 may generate and send an order to the server 103, and the server 103 may distribute the order to an order-receiving terminal device 101 based on the service area of the order-receiving user. In another embodiment, the order-receiving terminal device 101 may be configured to determine a service area of an order-receiving user, and obtain corresponding orders from orders generated by the one or more order-generating terminal device 102 based on the determined service area. The detailed methods of order distribution will be described with reference to specific embodiments.

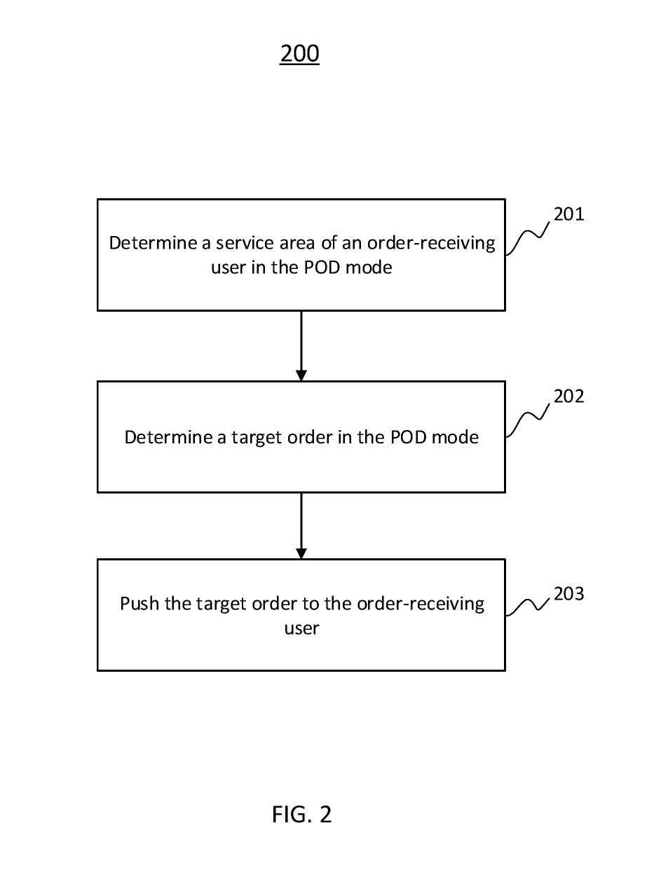

FIG. 2 is a flow diagram illustrating a method 200 of order distribution in a preset order distribution mode in accordance with an exemplary embodiment of the present application. The method 200 may be performed by a terminal (for example, the order-receiving terminal device 101) or a server (for example, server 103 in FIG. 1). In some embodiments, the method 200 is performed by a terminal device installed with a vehicle hailing application. It will be appreciated by those skilled in the art that the terminal device may include, but is not limited to, a mobile terminal device such as a smartphone, an intelligent wearable device, a tablet, a personal digital assistant, and the like.

As shown in FIG. 2, at step 201, a service area of an order-receiving user is determined in a preset order distribution (POD) mode. A POD mode is a mode in which orders are distributed in a predetermined manner. Generally, there may be a plurality of ways to distribute an order to an order-receiving user, and an appropriate order distribution mode may be selected according to different scenarios or conditions to optimize the order distribution process for certain scenarios or conditions. For example, when a certain event occurs, a mode that matches the event may be selected to optimize the order distribution.

In some embodiments, an order-receiving user is a user who receives orders and provides services. For example, an order-receiving user can be a driver (in a scenario of vehicle hailing (including booking or hailing a taxi)), and can be a delivery person (in a scenario of ordering food delivery) and so on. An order-receiving user in one scenario may be an order-generating user, or a user of another status in other scenarios, and this application should not be limited in this aspect.

In some embodiments, a service area of an order-receiving user is an area where service is to be provided by the order-receiving user. The service area may be a city, a district, or any geographical area, and may enclose a starting point and an ending point where the service may be provided. In some embodiments, in a certain period of time, a geographical area may include one or more service areas. The service area of any particular order-receiving user within this geographical area may be determined by the physical location of the order-receiving user. Specifically, the physics location information of the order-receiving user may be first obtained, and the geographical area where the order-receiving user locates can then be determined. Then the service area of the order-receiving user can be determined within this geographical area.

At step 202, a target order may be determined from orders to be distributed based on the service area in the POD mode.

In some embodiments, orders to be distributed in the POD mode may refer to the orders generated and sent by the order-generating users. An order-generating user is a user who generates and sends an order, i.e., requests a service. For example, an order-generating user can be a passenger who is hailing a vehicle (in a scenario of vehicle hailing), or can be a person who orders a food delivery (in a scenario of ordering food delivery) and so on. An order-generating user in one scenario may be an order-receiving user, or a user of another status in other scenarios, and this application should not be limited in this aspect.

In general, for an O2O service, an order usually includes a starting point and an ending point where the service may be provided. Therefore, a geographical area where an order-receiving user (i.e., service provider) may provide services should at least cover the starting point and the ending point during a service providing process. In other words, the starting and ending points of the order that is pushed to an order-receiving user should be enclosed in the service area of the order-receiving user.

First, an order to be distributed can be analyzed, and its corresponding starting point and ending point can be obtained. If the starting point and the ending point are both within the service area of the order-receiving user, then the order can be considered as a candidate order for the order-receiving user. Similarly, all orders to be distributed can be analyzed, and a plurality of candidate orders for the order-receiving user can be obtained based the starting point and ending point of each order. Next, among the plurality of candidate orders, a target order can be selected to send to the order-receiving user.

To select the target order, any reasonable method can be used. In one embodiment, the target order can be selected by the closest starting point to the order-receiving user. In other words, among the plurality of candidate orders, the order of which the starting point is closest to the order-receiving user is selected as the target order. In another embodiment, a candidate order may be selected as the target order if the candidate order's direction is the same as the moving direction of the order-receiving user. The candidate order's direction may refer to the direction from the starting point to the ending point. In another embodiment, the target order may be selected randomly from a plurality of candidate orders. It is to be understood that the target order may be selected from the candidate orders using any other reasonable means or rules, and this application does not limit the particular way of determining the target order from the candidate orders.

At step 203, the target order is pushed to the order-receiving user.

The method 200 may be performed by a terminal or a server. In some embodiments, the method 200 is performed by a terminal device, and the terminal device may be equipped with an O2O service client application (e.g., a vehicle hailing application, a delivery application, etc.). An identity of the account that the O2O service client application uses to log in can be configured as an identity of the service (e.g., a driver, a delivery person, etc.). Therefore, the user of the terminal device may be configured as the order-receiving user.

When the service client application detects that the POD mode is turned on, it may first determine the service area of the user of the terminal device, i.e. the service area of the order-receiving user. Next, based on the service area, a target order may be obtained from the candidate orders in the POD mode. Then, the target order is pushed to the user of the terminal device (i.e. the order-receiving user), and information of the target order may be displayed on a screen of the terminal device.

In some embodiments, the method 200 may be performed by a server. The server may be a server that can provide O2O services for clients, such as vehicle hailing applications, or delivery applications, etc. The server may be able to detect order-generating users and order-receiving users in the POD mode. First, the server may determine the service area of each of the order-receiving users. Then the server may obtain a target order for each of the order-receiving users among the orders to be distributed in the POD mode, based on the determined service area of each of the order-receiving users. Then the target order can be pushed to the corresponding order-receiving user.

The method 200 of order distribution provided by the above-described embodiments of the present application may allocate service resources to an area with a greater demand for services, thus reducing waste of service resources, and improving efficiency of the services.

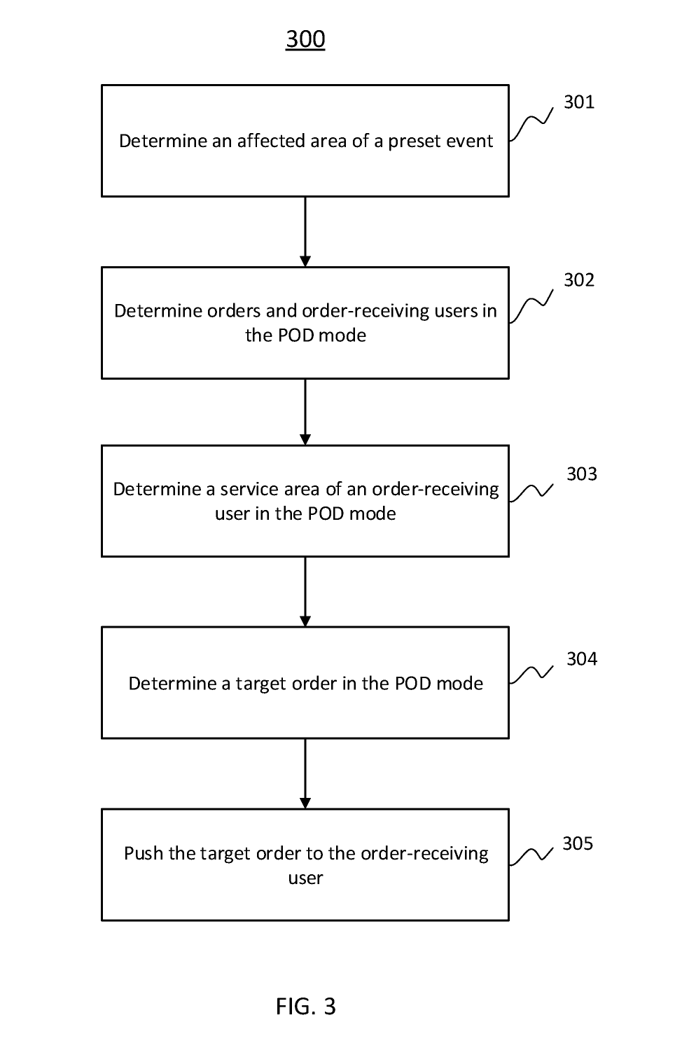

FIG. 3 is a flow diagram illustrating another method 300 of order distribution in a POD mode in accordance with an exemplary embodiment of the present application. The method 300 may be performed by a terminal or a server. In some embodiments, the method 300 is performed by a terminal device installed with a vehicle hailing application. It will be appreciated by those skilled in the art that the terminal device may include, but is not limited to, a mobile terminal device such as a smartphone, an intelligent wearable device, a tablet, a personal digital assistant, and the like.

As shown at step 301, when a preset event is detected or determined, an affected area of the preset event may be determined.

In some embodiments, a preset event may be a type of hazardous weather, and the weather type can be preset as, for example, blizzard, tornado, rainstorm, etc. A preset event may be a national holiday, for example, Spring Festival, National Day, etc. A preset event may be a social event, for example, an international conference, a ball game, Olympic Games, etc. It will be appreciated that the preset event may also be other events, and this application is not limited in this aspect.

In general, when a preset event occurs, a large scale of traffic may be affected. An affected area of a preset event can be defined as an area where traffic may be affected by the preset event. In one embodiment, a preset event may be a rainstorm, and the corresponding affected area may be the area where the rain falls. In another embodiment, a preset event may be a traffic congestion, and the corresponding affected area may be the area where traffic is jammed.

At step 301, whether a preset event has occurred may be first detected by a terminal/server. In one embodiment, weather information may be obtained to determine whether the preset weather event (e.g., blizzard, tornado, rainstorm, etc.) has occurred. In another embodiment, traffic condition in a local area (e.g. a city, a town, a district, etc.) may be obtained to determine whether a preset traffic event has occurred. The traffic condition may include traffic condition in each road where the traffic congestion occurs. It will be appreciated that it is also possible to detect, by other means, whether a preset event has occurred, and this application is not limited to the particular aspect of detecting whether a preset event has occurred.

Once a preset event is detected, the next is to determine the affected area of the preset event. Different preset events may correspond to different methods for determining their corresponding affected areas. The methods can be designed and stored on the terminal/sever. When a specific preset event is detected, the terminal/server may first determine which preset event it is, and then find out the corresponding method to determine the affected area that may be affected by the specific preset event.

For example, if a preset event is detected as a rainstorm, then the terminal/server can first determine the affected area of the rainstorm. In one method, the affected area of a rainstorm may be set as all areas where rain falls. Based on this method, the terminal/server can search for all areas where rains fall, for example, based on whether forecast obtained online, and set these areas as the affected area of the preset event (rainstorm). In another example, if a preset event is detected as a traffic congestion, then the terminal/server can first determine the affected area of a traffic congestion. In one method, a traffic congestion index may be defined to indicate a degree of the traffic congestion. A person having ordinary skill in the art should appreciate that there are many ways to obtain traffic information, for example, from map applications on the terminal or server, or from online map applications, traffic reports. In one embodiment, the software application on the terminal or server that performs the method of this application may generate its own traffic information based on the information it collects from users of the software application. When an area has a traffic congestion index that is larger than a threshold value, and the size of the area is also larger than a threshold size, the area may be included in the affected area of the preset event. The threshold value of the traffic congestion index and the threshold size of an area can be pre-determined values. Based on this method, the terminal/server can search for all areas whose traffic index are larger than the threshold value and sizes are larger than the threshold size. These areas then can be set as the affected area of the preset event (traffic congestion). It is to be understood that the affected area of a preset event may also be determined by other means, and the present application is not limited to the specific way of determining the affected area of a preset event.

At step 302, based on the affected area of the preset event, orders and order-receiving users in the POD mode can be determined. As a preset event occurs, traffic condition within the affected area may be influenced. Therefore, a POD mode can be turned on within the affected area. By distributing orders in the POD mode, order distribution process can be optimized when a preset event occurs.

In one embodiment, a location of an order-receiving user can be obtained, and can be used to determine whether the order-receiving user is in the affected area. The order-receiving user whose location is in the affected area can be determined as the order-receiving user in the POD mode. In the meanwhile, a location of an order-generating user can also be obtained, and can be used to determine whether the order-generating user is in the affected area. The order-generating user whose location is in the affected area can be determined as the order-generating user in the POD mode. Accordingly, an order from the order-generating user in the POD mode can be determined as the order in the POD mode.

In another embodiment, a server may send out inquires to order-receiving users and order-generating users whose locations are in the affected area. For example, an inquiry may be “Would you like to be an order-receiving user in the POD mode?” Order-receiving users who have confirmed the inquiries are determined as the order-receiving users in the POD mode. Similarly, orders from order-generating users who have confirmed the inquiries are determined as the orders in the POD mode.

At step 303, a service area of an order-receiving user is determined in POD mode. At step 304, a target order may be determined from orders in the POD mode based on the determined service area in the POD mode. At step 305, the target order is pushed to the order-receiving user in the POD mode. Details of steps 303-305 are similar to the method 200 of order distribution, and not repeated here again.

The method 300 may be performed by a terminal or a server. In some embodiments, the method 300 is performed by a terminal device, and a user of the terminal device can be an order-receiving user. The terminal device may first detect whether a preset event has occurred. For example, the terminal device may obtain some real-time information such as weather information, traffic information, or the like in the current location (e.g., city, district, county, etc.). Then, based on the real-time information, the terminal device may determine whether a preset event has occurred. When a preset event is detected, the affected area of the preset event is determined and the POD mode is further determined based on the determined affected area. If the POD mode is enabled, then the order-receiving user is determined as the order-receiving user in the POD mode. At the same time, the terminal device can also determine order-generating users who are within the affected area and also have turned on the POD mode as the order-generating users in the POD mode. Accordingly, orders from the order-generating users in the POD mode can be determined as the orders in the POD mode.

In some embodiments, the method 300 may be performed by a server. The server may detect whether a preset event has occurred in a server's working area, i.e., an area that the server serves. The server may first obtain real-time information within the working area, such as weather information, traffic information, etc. Then based on the real-time information, the server may be able to determine whether a preset event has occurred. When a preset event is detected, the affected area of the preset event is determined and the POD mode is further determined based on the determined affected area. Next, order-receiving users who are within the affected area and have also enabled the POD mode can be determined as the order receiving users in the POD mode. At the same time, the server can also determine order-generating users who are within the affected area and also turned on the POD mode as the order-generating users in the POD mode. Accordingly, orders from the order-generating users in the POD mode can be determined as the orders in the POD mode.

In the present application, the method 300 of order distribution may determine an affected area of a preset event when the preset event is detected. Based on the affected area, order-receiving users and orders in the POD mode can be determined. For any specific order-receiving user, the corresponding service area can be determined. Based on the service area, a target order can be selected from the orders in the POD mode, and pushed to the order-receiving user. Therefore, in a preset event, services can be focused on the area affected by the preset event where a greater demand for services is requested. Thus, the method 300 of order distribution may help reduce waste of service resources, and also further improve efficiency of services.

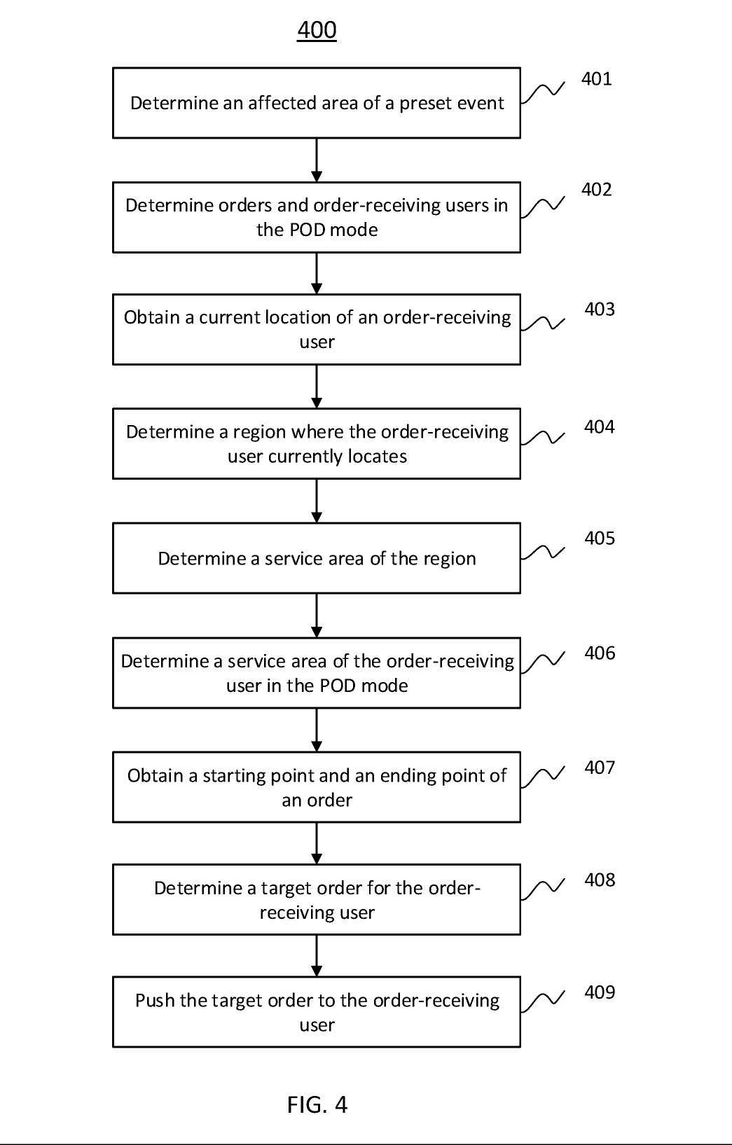

FIG. 4 is a flow diagram illustrating another method 400 of order distribution in a POD mode in accordance with embodiments of the present application. The method 400 present a process for determining a service area of an order-receiving user in the POD mode, and another process for obtaining a target order from orders in the POD mode based on the service area. The method 400 can be performed by a terminal or by a server. The method 400 may include the following steps:

At step 401, when a preset event is detected, an affected area by the preset event may be determined.

At step 402, based on the affected area of the preset event, orders and order-receiving users in the POD mode can be determined.

At step 403, a current location of an order-receiving user can be obtained. In some embodiments, position data of an order-receiving user in the POD mode may be obtained, and this position data may be used as a current location of the order-receiving user.

At step 404, a region where the order-receiving user currently locates can be determined. In some embodiments, the region can be a geological location. In some embodiments, the region can be a city (for example, Beijing, Shanghai, etc.), or a county or a district. It is to be understood that the region may also be an area divided by other means, and the specific aspect of the application of the present application is not limited. In some embodiments, the region where the order-receiving user currently locates can be determined based on the current location of the order receiving user.

At step 405, a service area of the region can be determined based on the region where the order-receiving user currently locates, and the service area of the region can be defined as a first area.

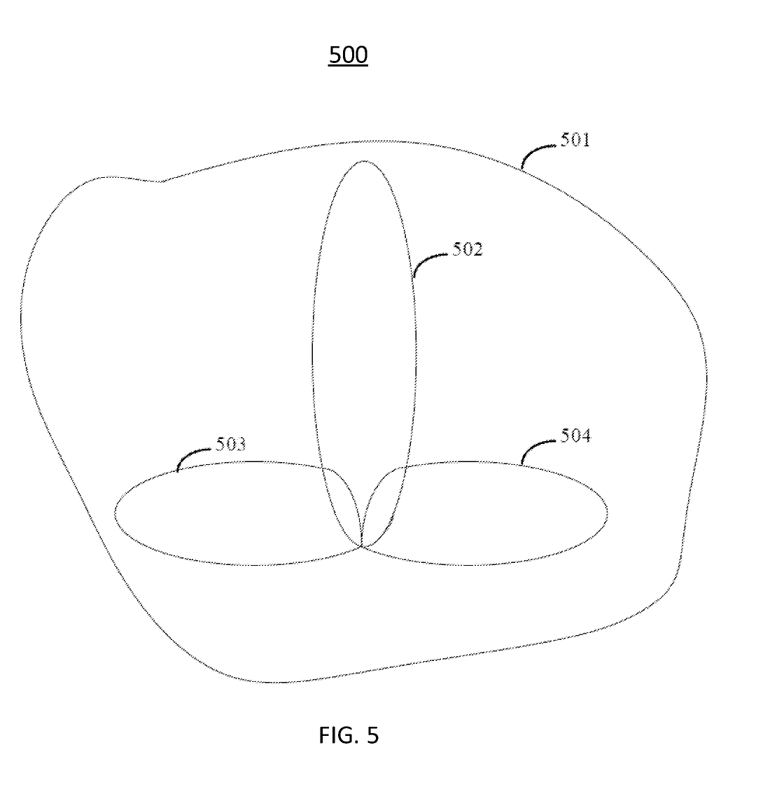

In some embodiments, the region where the order-receiving user currently locates may correspond to one or more service areas. As shown in FIG. 5, the region 501 may correspond to 3 service areas, 502, 503 and 504. Specifically, a service area of the region can be an area where a large amount of services are requested. If this service area is affected by a preset event, the amount of services requested may be increased, and may affect efficiency of services. Therefore, a service area may be a pre-determined area or an area determined based on historical order data, or may be an area determined based on current order data.

In some embodiments, for each region, areas that have a large amount of service requests can be set as service areas of the region based on real-time information and statistic data. Take hailing a taxi for example, a large amount of taxi hailing requests may be generated between a downtown and a subway station in a city, then the area between the downtown and the subway station may be set as a service area of the region. These pre-determined service areas may be stored in association with the corresponding regions. A service area associated with any region can be obtained from the stored data, and used for determining the service area of the region.

In some embodiments, a service area of the region can be determined based on routes of historical orders. For example, historical order data can be retrieved in any given period of time. Among the historical order data, the orders of which services have been completed can be selected, and the routes used in these completed orders can be obtained and analyzed. If a routes has been used more than certain number of times (threshold times), then the route can be set as a reference route. Based on the reference routes, a service area of the region can be defined as an area that encloses one or more reference routes.

In some embodiments, the order data generated in the region within a given period of time can be obtained. Then the route used in each of these generated orders can also be obtained and analyzed. If a route has been used more than certain number of times (threshold times), then the route can be set as a reference route. Based on the reference routes, a service area of the region can be defined as an area that encloses one or more reference routes.

In some embodiments, one or more independent areas can be set based on reference routes. Each of the independent area can enclose one or more complete reference route, and the independent areas may overlap with each other. Each of the independent area can be set as a service area of the region.

At step 406, a service area of the order-receiving user can be selected from the first area. In some embodiments, the first area may include one or more independent areas, and a service area of the order receiving user can be selected from the independent areas. Specifically, an area that corresponds to the current location of the order-receiving user can be obtained within the first area, and this area can be defined as a second area. Then based on the second area, the service area of the order receiving user can be determined. There may be one or more first areas, and the first areas may overlap with each other. There can also be one or more second areas correspond to each of the first area.

In some embodiments, the second area can be directly considered as the service area of the order-receiving user. In some embodiments, the order-receiving user can determine the service area from the one or more second areas. In some embodiments, the service area can be determined based on the amount of the order requests. The second area where the largest amount of orders are requested can be selected as the service area of the order-receiving user.

At step 407, a starting point and an ending point of an order can be obtained.

At step 408, the order whose starting and ending points are enclosed in the service area of the order-receiving user can be selected as a target order for the order-receiving user.

At step 409, the target order is pushed to the order-receiving user.

In one exemplary embodiment, for example, a city is having a rainstorm. Clients who are using vehicle hailing applications may switch to a POD mode. In the POD mode, current locations of vehicle drivers (an example of order-receiving users) can be determined. For example, a vehicle driver is at a subway station. Next, based on the current location, a service area of the vehicle driver can be determined. If the vehicle driver is in a location covered by one or more service areas, then these service areas can be reported to the vehicle driver, and the vehicle driver can decide which service area he belongs to. Or the service area can be determined as the area that has the largest amount of order requests. For example, if the service area is an area between the downtown and the subway station, then only the orders whose starting and ending points are enclosed in the service area may be pushed to the vehicle driver.

The present embodiment is not limited to the above-described application scenario, and may be applied to other scenarios. The method of order distribution provided in the present application, when detects a preset event, may determine the affected area of the preset event, and then determine the order-receiving users and orders in the POD mode based on the affected area. The method may include obtaining the current location of an order-receiving user, determining a region where the order-receiving user currently locates, determining a service area of the region which is defined as the first area, and then determining the service area of the order-receiving user within the first area. Then a target order can be determined based on the service area of the order-receiving user, and be pushed to the order-receiving user. In a preset event, services can be focused on the area affected by the preset event where a greater demand for services is requested. Thus, the method of order distribution may help reduce waste of service resources, and also further improve efficiency of services.

In some embodiments, the method described above may further comprise: outputting relevant information of the service area of the region where the order-receiving user currently locates. The relevant information may include server site information in the service area and the order information within the service area. For example, assuming that the region where the order-receiving user currently locates is Beijing, the method may include outputting information of all the service areas and their related information in Beijing area. The relevant information may include each site information within the service area and the order information in the service area. The order-receiving user may use the relevant information to select the service area where a large amount of orders are requested as the service area of the order-receiving user, thus reducing waste of service resources, and improving the efficiency of services.

It should be noted that although the operation of the method of the present application has been described in a specific order in the drawings, it is not intended or implied that such operations must be performed in that particular order or that all of the operations shown must be performed in order to achieve the desired result. The order of the steps can be changed. Additionally or alternatively, certain steps may be omitted, a plurality of steps may be combined into one step, and/or a step may be decomposed into a plurality of steps.

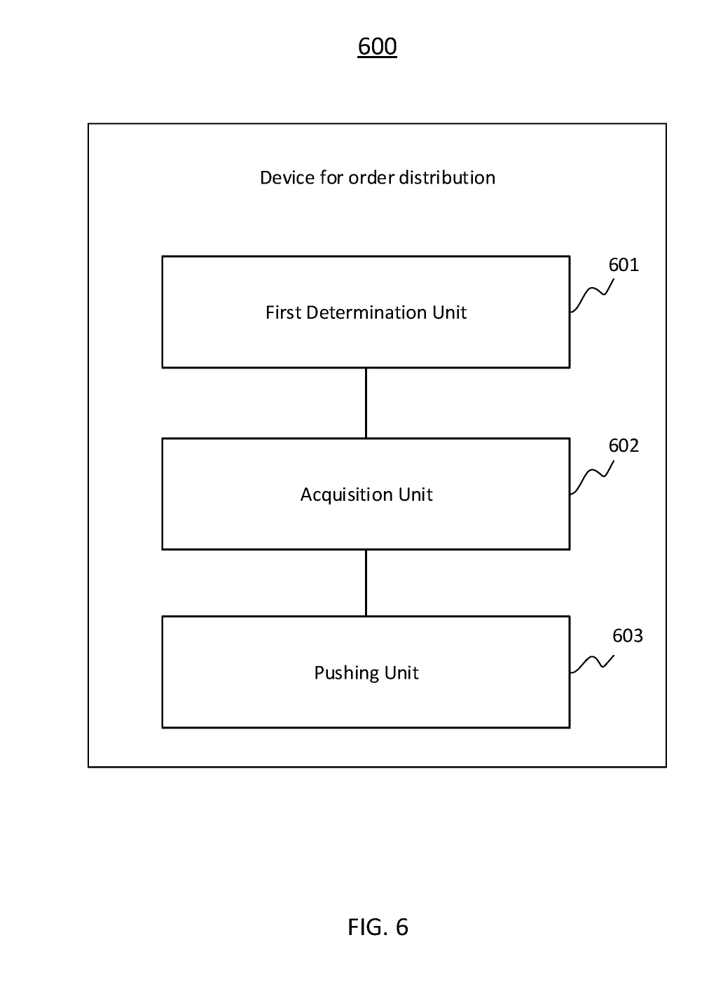

FIG. 6 is a block diagram of a device 600 for order distribution in the POD mode in accordance with an exemplary embodiment of the present application. The device 600 may include a first determination unit 601, an acquisition unit 602, and a pushing unit 603.

The first determination unit 601 may be configured to determine a service area of an order-receiving user in the POD mode. The acquisition unit 602 may be configured to obtain a target order from orders to be distributed in the POD mode based on the service area described above. The pushing unit 603 may be configured to push the target order to the order-receiving user.

In some alternative embodiments, the device 600 may further include a second determination unit and a third determination unit (not shown in FIG. 6). The second determination unit may be configured to determine an affected area of a preset event when the preset event is detected. The third determination unit may be configured to determine the order and the order-receiving user based on the affected area.

In some embodiments, the third determination unit may be further configured to: determine the order-receiving users in the affected area as the order-receiving users in the POD mode; and determine the orders that are generated by the order-generating users in the affected area as the orders in the POD mode.

In some embodiments, the third determination unit may be configured to: send queries to order-generating users and order-receiving users in the affected area; set the order-receiving users who have responded to the queries as the order-receiving users in the POD mode; and set the orders from the order-generating users who have responded to the queries as the orders in the POD mode.

In some embodiments, the first determination unit 601 may include a first acquisition subunit, a determination subunit, a second acquisition subunit and a third acquisition subunit (no shown in FIG. 6).

The first acquisition subunit may be configured to obtain the current location of an order-receiving user. The determination subunit may be configured to determine the region where the order-receiving user currently locates. The second acquisition subunit may be configured to determine the service area of the region where the order-receiving user currently locates, and set the service area of the region as the first area. The third acquisition subunit may be configured to determine the service area of the order-receiving user within the first area. In some embodiments, the second acquisition subunit may be configured to obtain a service area that is relevant to the region in the stored data, and determine this service area as the service area of the region.

In some embodiments, the second acquisition unit may be configured to obtain historical data of completed orders in the region in a certain period of time; obtain the route used in each of these completed orders in the historical data; select routes that have been used more than certain number of times (threshold times) and set the routes as reference routes; and determine the service area of the region based on the reference routes.

In some embodiments, the second acquisition unit may be configured to obtain data of orders generated in the region within a certain period of time; obtain the route used in each of these generated orders from the data; select routes that have been used more than certain number of times (threshold times) and set the routes as reference routes; and determine the service area of the region based on the reference routes.

In some embodiments, the third acquisition subunit may be configured to obtain one or more areas within the first area that cover the region where the order-receiving user currently locates, set the one or more areas as second areas; and determined the second areas as the service area of the order-receiving user. In some embodiments, the third acquisition subunit may be configured to obtain one or more areas within the first area that cover the region where the order-receiving user currently locates, set the areas as the second areas; output the second areas to the order-receiving user for selection; and determine the second area that is selected by the order-receiving user as the service area of the order-receiving user. In some embodiments, the third acquisition subunit may be configured to obtain one or more areas within the first area that cover the region where the order-receiving user currently locates, set the areas as the second areas; obtain current order requests in each of the second areas; and determine the second area with the largest amount of current order requests as the service area of the order-receiving user.

In some embodiments, the acquisition unit may further comprise: a starting and ending point acquisition subunit and a distribution subunit (not shown in FIG. 6). The starting and ending points acquisition subunit may be configured to obtain a starting point and an ending point of an order. The distribution subunit may be configured to selecting a target order from the orders whose starting and ending points are enclosed in the service area.

In some embodiments, the acquisition unit may further comprise an output unit (not shown in FIG. 6). The output unit may be configured to output information of the service area of the region where the order-receiving user currently locates. The information may include information of server sites in the service area and information of order requests in the service area.

In some embodiments, the preset event may include one or more of preset weather-type events and traffic congestions.

It should be understood by a person having ordinary skill in the art that the above-described device may be installed in a terminal or a server in advance, or may be loaded into a terminal or a server by downloading or the like. The corresponding units in the above-described devices may cooperate with units in the terminal or server to perform the order distribution.

Embodiments of the present disclosure are described with reference to flow diagrams and/or block diagrams of methods, devices (systems), and computer program products according to embodiments of the present disclosure. It will be understood that each flow and/or block of the flow diagrams and/or block diagrams, and combinations of flows and/or blocks in the flow diagrams and/or block diagrams, can be implemented by computer program instructions. These computer program instructions may be provided to a processor of a computer, an embedded processor, or other programmable data processing devices to produce a special purpose machine, such that the instructions, which are executed via the processor of the computer or other programmable data processing devices, create a means for implementing the functions specified in one or more flows in the flow diagrams and/or one or more blocks in the block diagrams.

The flowcharts and block diagrams in the accompanying drawings show system architectures, functions, and operations of possible implementations of the system and method according to multiple embodiments of the present invention. Each block in the flowchart or block diagram may represent one unit/module, one program segment, or a part of code, where the unit/module, the program segment, or the part of code includes one or more executable instructions used for implementing specified logic functions. It should also be noted that, in some alternative implementations, functions marked in the blocks may also occur in a sequence different from the sequence marked in the drawing. For example, two consecutive blocks actually can be executed in parallel substantially, and sometimes, they can also be executed in reverse order, which depends on the functions involved.

As will be understood by those skilled in the art, embodiments of the present disclosure may be embodied as a method, a system or a computer program product. Accordingly, embodiments of the present disclosure may take the form of an entirely hardware embodiment, an entirely software embodiment or an embodiment combining software and hardware for allowing specialized components to perform the functions described above. Furthermore, embodiments of the present disclosure may take the form of a computer program product embodied in one or more tangible and/or non-transitory computer-readable storage media containing computer-readable program codes. Common forms of non-transitory computer readable storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same.

The computer program instructions may also be loaded onto a computer or other programmable data processing devices to cause a series of operational steps to be performed on the computer or other programmable devices to produce processing implemented by the computer, such that the instructions (which are executed on the computer or other programmable devices) provide steps for implementing the functions specified in one or more flows in the flow diagrams and/or one or more blocks in the block diagrams. In a typical configuration, a computer device includes one or more Central Processing Units (CPUs), an input/output interface, a network interface, and a memory. The memory may include forms of a volatile memory, a random access memory (RAM), and/or non-volatile memory and the like, such as a read-only memory (ROM) or a flash RAM in a computer-readable storage medium. The memory is an example of the computer-readable storage medium.

The various devices described above are mainly for illustration. The embodiments of the device described above are merely illustrative, wherein the units and subunits described as the separating means may or may not be physically separated, and the units and subunits may or may not be a physical unit. The units and subunits may physically locate in one place, or they may exist in forms of network elements. Part or whole of the device may be selected and implemented according to actual requirements and conditions. One with ordinary skill in the art will understand and practice without inventive steps.

The invention described and claimed herein is not to be limited in scope by the specific preferred embodiments disclosed herein, as these embodiments are intended as illustrations of several aspects of the invention. Indeed, various modifications of the invention in addition to those shown and described herein will become apparent to those skilled in the art from the foregoing description. Such modifications are also intended to fall within the scope of the appended claims.

1. A method implemented on a computing device for order distribution, the computing device including a memory and one or more processors, the method comprising:
determining, by the one or more processors, in a preset order distribution (POD) mode, a service area of an order-receiving user;
determining, by the one or more processors, a target order from orders to be distributed based on the service area of the order-receiving user; and
pushing, by the one or more processors, the target order to the order-receiving user.

2. The method of claim 1, wherein, prior to the determining the service area of the order-receiving user, the method further comprises:
determining, by the one or more processors, an affected area of a preset event when the preset event is detected; and
determining, by the one or more processors, the orders to be distributed and the order-receiving user in the POD mode based on the affected area of the preset event.

3. The method of claim 2, further comprising:
sending, by the one or more processors, signals including inquires to order-receiving users and order generating users in the affected area;
determining, by the one or more processors, order-receiving users who have confirmed the inquiries as the order-receiving users in the POD mode; and
determining, by the one or more processors, orders from order-generating users who have confirmed the inquiries as the orders in the POD mode.

4. The method of claim 1, further comprising:
obtaining, by the one or more processors, signals including a current location of the order-receiving user;
determining, by the one or more processors, a region where the order-receiving user currently locates;
determining, by the one or more processors, a service area of the region, wherein the service area of the region is set as a first area; and
determining, by the one or more processors, the service area of the order-receiving user within the first area.

5. (canceled)

6. The method of claim 4, wherein determining the service area of the region comprises:
obtaining, by the one or more processors, signals including historical order data in a given period of time in the region, wherein the historical order data is data of completed orders;
obtaining, by the one or more processors, signals including routes used in the completed orders;
setting, by the one or more processors, a route that has been used more than a first threshold times as a first reference route; and
determining, by the one or more processors, the service area of the region based on the first reference route; or
obtaining, by the one or more processors, signals including order data generated in the region within a given period of time;
obtaining, by the one or more processors, signals including routes used in the generated orders;
setting, by the one or more processors, a route that has been used more than a second threshold times as a second reference route; and
determining, by the one or more processors, the service area of the region based on the second reference route.

7. (canceled)

8. The method of claim 4, wherein determining the service area of the order-receiving user within the first area comprises:
obtaining, by the one or more processors, signals including an area within the first area that covers the region where the order-receiving user currently locates, wherein the area is set as a second area; and
determining, by the one or more processors, the second area as the service area of the order-receiving user.

9. The method of claim 4, wherein determining the service area of the order-receiving user within the first area comprises:
obtaining, by the one or more processors, signals including one or more areas within the first area that cover the location where the order-receiving user currently locates as second areas;
outputting, by the one or more processors, signals including the second areas to the order-receiving user for selection; and
determining, by the one or more processors, the selected second area as the service area of the order-receiving user; or
obtaining, by the one or more processors, signals including one or more areas within the first area that cover the location where the order-receiving user currently locates as second areas;
obtaining, by the one or more processors, signals including order requests in each second area; and
determining, by the one or more processors, the second area with a largest number of order requests as the service area of the order-receiving user.

10. (canceled)

11. The method of claim 1, wherein determining the target order from orders to be distributed based on the service area of the order-receiving user, comprises:
obtaining, by the one or more processors, signals including a starting point and an ending point of each order; and
determining, by the one or more processors, the order whose starting point and ending point are enclosed in the service area of the order-receiving user as the target order.

12-26. (canceled)

27. A non-transitory computer-readable medium for order distribution, comprising instructions stored therein, wherein the instructions, when executed by one or more processors, cause the one or more processors to perform a method comprising:
determining, in a preset order distribution mode, a service area of an order-receiving user;
determining a target order from orders to be distributed based on the service area of the order-receiving user; and
pushing the target order to the order-receiving user.

28. A system configured for order distribution, comprising:
at least one non-transitory storage medium including a set of instructions; and
one or more processors in communication with the at least one non-transitory storage medium, wherein when executing the set of instructions, the one or more processors are directed to:
determine, in a preset order distribution (POD) mode, a service area of an order-receiving user;
determine a target order from orders to be distributed based on the service area of an order-receiving user; and
push the target order to the order-receiving user.

29. The system of claim 28, wherein, prior to determine the service area of the order-receiving user, the one or more processors are directed to:
determine an affected area of a preset event when the preset event is detected; and
determine the orders to be distributed and the order-receiving user in the POD mode based on the affected area of the preset event.

30. The system of claim 29, wherein the one or more processors are further directed to:
send signals including inquires to order-receiving users and order generating users in the affected area;
determine order-receiving users who have confirmed the inquiries as the order-receiving users in the POD mode; and
determine orders from order-generating users who have confirmed the inquiries as the orders in the POD mode.

31. The system of claim 28, wherein the one or more processors are further directed to:
obtain signals including a current location of the order-receiving user;
determine a region where the order-receiving user currently locates;
determine a service area of the region, wherein the service area of the region is set as a first area; and
determine the service area of the order-receiving user within the first area.

32. The system of claim 31, wherein to determine the service area of the region, the one or more processors are further directed to:
obtain signals including historical order data in a given period of time in the region, wherein the historical order data is data of completed orders;
obtain signals including routes used in the completed orders;
set a route that has been used more than a first threshold times as a first reference route; and
determine the service area of the region based on the first reference route.

33. The system of claim 31, wherein to determine the service area of the region, the one or more processors are further directed to:
obtain signals including order data generated in the region within a given period of time;
obtain signals including routes used in the generated orders;
set a route that has been used more than a second threshold times as a second reference route; and
determine the service area of the region based on the second reference route.

34. The system of claim 31, wherein to determine the service area of the order-receiving user within the first area, the one or more processors are further directed to:
obtain signals including an area within the first area that covers the region where the order-receiving user currently locates, wherein the area is set as a second area; and
determine the second area as the service area of the order-receiving user.

35. The system of claim 31, wherein to determine the service area of the order-receiving user within the first area, the one or more processors are further directed to:
obtain signals including one or more areas within the first area that cover the location where the order-receiving user currently locates as second areas;
output signals including the second areas to the order-receiving user for selection; and
determine the selected second area as the service area of the order-receiving user.

36. The system of claim 31, wherein to determine the service area of the order-receiving user within the first area, the one or more processors are further directed to:
obtain signals including one or more areas within the first area that cover the location where the order-receiving user currently locates as second areas;
obtain signals including order requests in each second area; and
determine the second area with a largest number of order requests as the service area of the order-receiving user.

37. The system of claim 28, wherein to determine the target order from orders to be distributed based on the service area of the order-receiving user, the one or more processors are further directed to:
obtain signals including a starting point and an ending point of each order; and
determine the order whose starting point and ending point are enclosed in the service area of the order-receiving user as the target order.

38. The system of claim 28, wherein the one or more processors are further directed to:
output signals including relevant information of the service area of the region where the order-receiving user currently locates, wherein the relevant information includes order information in the service area of the region.

39. The system of claim 29, wherein the preset event includes a preset weather type event or a traffic congestion.
